(19) United States
(12) Patent Application Publication
(10) Pub. No.: US 2016/0107173 A1
(43) Pub. Date: Apr. 21, 2016

(54) CENTRIFUGE

(71) Applicant: TOMOE ENGINEERING CO., LTD., Shinagawa-ku, Tokyo (JP)

(72) Inventors: Qun Ce FENG, Tokyo (JP); Kensuke OZAWA, Tokyo (JP)

(21) Appl. No.: 14/892,351

(22) PCT Filed: Jun. 14, 2013
(86) PCT No.: PCT/JP2013/003738

§ 371 Date: Nov. 19, 2015

(51) Int. Cl. B04B 11/05; B04B 1/02

(52) U.S. Cl. CPC B04B 11/05; B04B 1/02

(57) ABSTRACT

A centrifuge has a bowl, an opening at the center of the lower part of the bowl for supplying liquid to be treated and for discharging a centrifugally separated solids cake, and a tapered section configured so that the radius of the inner peripheral surface of the tapered section reduces downward toward the opening. Protrusions are provided at circumferential locations on the inner peripheral surface of the tapered section and protrude from the inner peripheral surface. A wing rotates within the bowl about the vertical axis and transports the separated solids cake toward the opening when rotating relative to the bowl. A drive mechanism moves the wing to a first height position and rotates the bowl and the wing together, or moves the wing to a second height position lower than the first height position and rotates the wing relative to the bowl.

### TECHNICAL FIELD

The present invention relates to a technique for automatically discharging a centrifugally separated solids cake out of a bowl of a centrifuge that performs centrifugal separation by using the bowl which rotates about a vertical rotation axis.

### BACKGROUND ART

A centrifuge that performs centrifugal separation by using a bowl which rotates about a vertical rotation axis has conventionally been known (for example, see Patent Literature 1).

The foregoing conventional centrifuge discharges a separated solids cake accumulated in the bowl from a discharge port provided in a lower part of the bowl after centrifugal separation.

### CITATION LIST

### Patent Literature

Patent Literature 1: WO2010/084782

### SUMMARY OF INVENTION

### Technical Problem

In the foregoing conventional centrifuge, the discharge port in the lower part of the bowl is structurally designed to be small as compared to the inner diameter of the bowl in the vertical center portion of the bowl. However, amass of separated solids cake (also referred to as “cake”) accumulated on the inner peripheral surface of the bowl after centrifugal separation is annularly accumulated along the inner surface of the bowl. The annularly-accumulated separated solids cake thus has a diameter greater than that of the discharge port of the bowl.

Consequently, if such an annularly-accumulated separated solids cake having a diameter greater than the discharge port is lowered toward the discharge port, the separated solids cake can collect in the bowl near the discharge port. This has sometimes made it difficult to discharge the separated solids cake.

Moreover, the binding of the annular separated solids cake accumulated on the inner peripheral surface of the ring may be high. In such a case, if a wing or the like provided inside the bowl is rotated relative to the bowl to attempt to discharge the separated solids cake, the annular separated solids cake can slide over the inner peripheral surface of the bowl. The separated solids cake can rotate integrally with the wing, and the separated solids cake may fail to be lowered to the discharge port in the lower part of the bowl.

The present invention has been made to solve the foregoing problem, and an object thereof is to provide a technique for automatically discharging a centrifugally separated solids cake out of a bowl of a centrifuge that performs centrifugal separation by using the bowl which rotates about a vertical rotation axis.

### Solution to Problem

To solve the foregoing problem, an aspect of the present invention relates to a centrifuge including: a bowl which rotates about a vertical axis, has an opening functioning as a supply port of a liquid to be treated and also functioning as a discharge port of a separated solids cake centrifugally separated from the liquid to be treated, the opening being provided in a center of a lower part of the bowl, and has a tapered section of which an inner peripheral surface decreases in radius downward toward the opening; protrusions which are provided in a plurality of circumferential locations on the inner peripheral surface of the tapered section of the bowl and protrude from the inner peripheral surface; a wing which rotates within the bowl about the vertical axis and conveys the separated solids cake in the bowl toward the opening when rotating relative to the bowl in a predetermined direction of rotation; and a drive mechanism which moves the wing to a first height position to integrally rotate the bowl and the wing, and moves the wing to a second height position lower than the first height position to rotate at least either one of the wing and the bowl so that the wing rotates relative to the bowl in the predetermined direction of rotation, wherein a portion of the wing corresponding to the protrusion is notched into a shape not to collide with the protrusions when the wing and the bowl rotate relative to each other.

### Advantageous Effects of Invention

As described in detail above, according to the present invention, a technique for automatically discharging a centrifugally separated solids cake out of the bowl of the centrifuge that performs centrifugal separation by using the bowl which rotates about a vertical rotation axis can be provided.

### BRIEF DESCRIPTION OF DRAWINGS

FIG. 1 is a schematic diagram for describing a configuration of a centrifuge according to a first embodiment.

FIG. 2 is a schematic configuration diagram showing a detailed configuration around a wing and a bowl.

FIG. 3 is a schematic exploded perspective view showing a positional relationship between the wing, a tapered section, and protrusions.

FIG. 4 is a conceptual diagram showing conveyance loci of a separated solids cake by the wing.

FIG. 5 is a schematic exploded perspective view showing a positional relationship between a wing, a tapered section, and protrusions.

FIG. 6 is a conceptual diagram showing a relationship between the tilts of an upper wing and a lower wing.

FIG. 7 is a perspective view showing a positional relationship between the upper wing and the lower wing in a direction of rotation.

FIG. 8 is a conceptual diagram showing conveyance loci of the separated solids cake by the wing.

FIG. 9 is a diagram showing a positional relationship between a notch of the wing lying in a first height position and a protrusion.

FIG. 10 is a diagram showing a positional relationship between the notch of the wing lying in a second height position and the protrusion.

FIG. 11 is a diagram showing a schematic configuration near a wing of a centrifuge according to a third embodiment of the present invention.

FIG. 12 is a schematic perspective view showing an example of a positional relationship between a wing, a tapered section, and grooves of a centrifuge according to a fourth embodiment of the present invention.

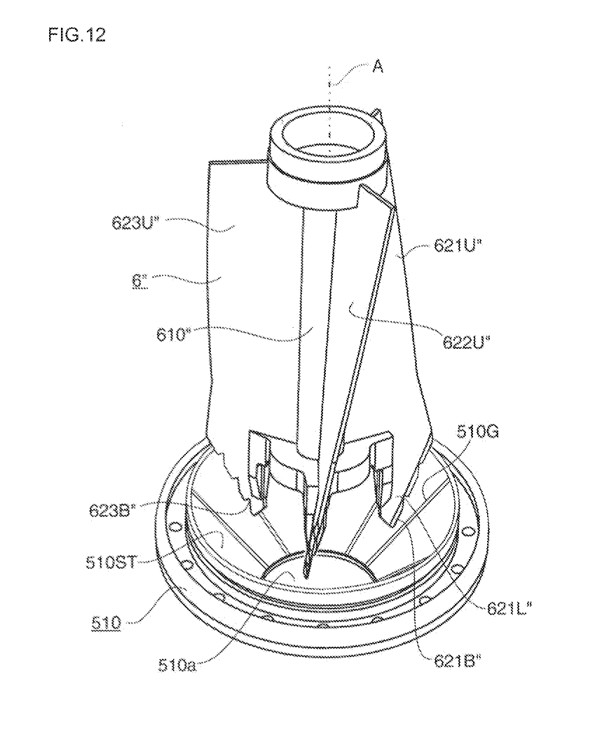

### DESCRIPTION OF EMBODIMENTS

Hereinafter, respective embodiments of the present invention will be described with reference to the drawings.

### First Embodiment

A first embodiment of the present invention will initially be described.

### <Apparatus Configuration>

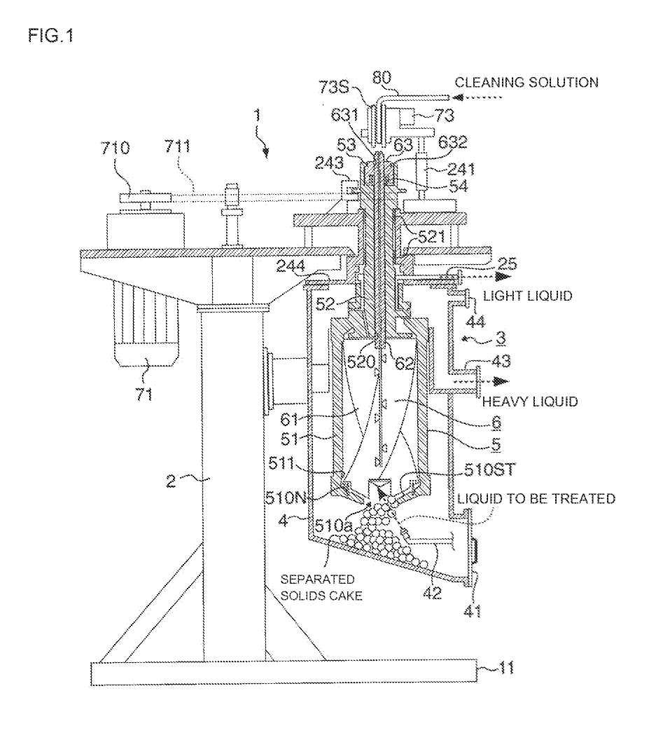

FIG. 1 is a schematic diagram for describing a configuration of a centrifuge according to the first embodiment. A centrifuge 1 centrifugally separates a liquid to be treated which is a target object of centrifugal separation processing into a liquid and a solids cake. If the liquid to be treated contains a plurality of types of liquids having different specific gravities, the centrifuge according to the present embodiment can separate the liquid to be treated into three, a light liquid having a low specific gravity, a heavy liquid having a high specific gravity, and a solids cake.

As shown in FIG. 1, the centrifuge 1 according to the present embodiment may be configured, for example, so that a vertical type centrifuge main body 3 is attached to a frame 2 which is provided on a base 11.

An end of an upper part of the frame 2 is detachably connected to an upper part of a casing 4 of the centrifuge main body 3 to be described later. A main body driving motor 71 is provided on the other end side.

For example, a cylinder 241 for moving a wing driving motor 73 in up/down directions with respect to the frame 2 and moving a position of a wing 6 serving as a discharge member to be described later in up/down directions, a brake 243 for making contact with an upper part of a rotating shaft 52 of a bowl 5 to be described later to stop rotation of the bowl 5, and the like are provided above a location on the one end side of the upper part of the frame 2 where the centrifuge main body 3 is attached. The cylinder 241 and the brake 243 are driven by respective not-shown actuators.

In the present embodiment, as an example, there are provided the main body driving motor 71 which is driven during centrifugal separation of the liquid to be treated and the wing driving motor 73 which is driven at the time of positioning of the bowl 5 and the wing 6 to be described later and at the time of a discharge operation of a solids cake occurring during centrifugal separation.

The main body driving motor 71 is attached to the frame 2 with its drive shaft protruding upward from the motor main body. A pulley 710 is attached to the drive shaft of the main body driving motor 71. Rotational driving force of the main body driving motor 71 is transmitted to the bowl 5 via a driving belt 711 stretched over the pulley 710.

The wing driving motor 73 is attached to the upper part of the frame 2 via the foregoing cylinder 241 and via a support member 244 so that its drive shaft is located coaxially with a rotating shaft 62 of the wing 6 to be described later. Here, the drive shaft of the wing driving motor 73 is arranged to be located below the wing driving motor 73 and opposed to an upper end of the rotating shaft 62 of the wing 6. The end of the drive shaft of the wing driving motor 73 and the upper end of the rotating shaft 62 of the wing 6 have a coupler structure so that the ends are engaged with each other when moved in mutually approaching directions.

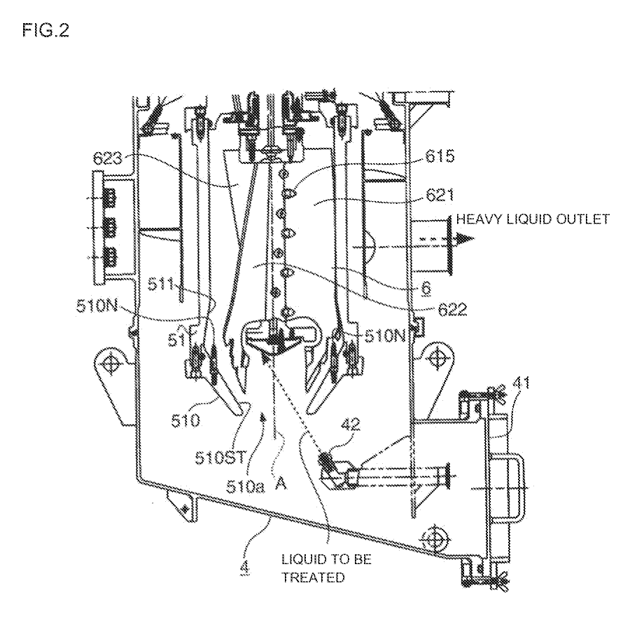

The centrifuge main body 3 includes the casing 4 which is connected to the frame 2 via the support member 244, the bowl 5 which is accommodated in the casing 4 so as to be rotatable about a vertical axis and is rotatably supported by the support member 244, and the wing 6 which is accommodated in the bowl 5 so as to be rotatable about a vertical axis A (see FIG. 2) and serves as a discharge member for discharging a solids cake in the bowl 5 out of the bowl.

One end side of a side surface of the casing 4 is connected to the frame 2 by a not-shown fastening bolt and the like. A heavy liquid discharge portion 43 for discharging a heavy liquid separated and generated during centrifugal separation of the liquid to be treated is provided on an upper part of the other end side of the side surface so as to protrude from the casing 4.

Moreover, a discharge port 44 for overflow is provided on the upper end side of the casing 4. The discharge port 44 can be used, for example, to let a cleaning solution overflow during water-filled cleaning inside the casing 4.

A detachable lid 41 is attached to a lower part of the casing 4.

Specifically, the support member 244 for supporting the casing, 4, the bowl 5, the wing 6, and the like is provided on the upper part of the frame 2.

An upper part of the casing 4 is detachably connected to a lower part of the support member 244. In other words, the lower part of the support member 244 also functions as a lid for covering the upper part of the casing 4. A light liquid discharge portion 25 for discarding a light liquid separated and generated during centrifugal separation of the liquid to be treated is provided on the support member 244 so as to communicate with an upper part of an internal space of the bowl 5.

The bowl 5 includes a bowl main body 51 to which the liquid to be treated is supplied, a tapered section 510 of generally lid shape which is detachably attached to a lower part of the bowl main body 51 by fixing means such as a bolt, and the rotating shaft 52 which is integrally provided on an upper part of the bowl main body 51 and supported by the support member 244 so as to be rotatable about a vertical axis.

The bowl main body 51 has a generally cylindrical shape smaller than the casing 4. The tapered section 510 has a generally annular shape in a plan view. A generally circular hole portion 510a (opening) which accepts the liquid to be treated supplied from a feed pipe 42 provided outside the bowl 5 and in the casing 4 and is intended to discharge a solids cake (cake) centrifugally separated in the bowl 5 out of the bowl 5 is formed in the center of the tapered section 510. As shown in FIG. 2, the tapered section 510 has a sectional shape such that the inner peripheral surface decreases in radius downward toward the hole portion 510a (opening) in order to facilitate discharging the solids cake (cake) in the bowl 5 as one of its functions.

The rotating shaft 52 of the bowl 5 is rotatably supported by the support member 244 via a bearing mechanism 521 such as a bearing. To rotatably support the wing 6, a hollow rotation support portion 520 is formed in the center of the rotating shaft 52 of the bowl 5. The wing 6 thus rotates within the bowl 5 about the vertical center axis A, and conveys the separated solids cake in the bowl toward the hole portion 510a (opening) when rotating relative to the bowl 5 in a predetermined rotation direction.

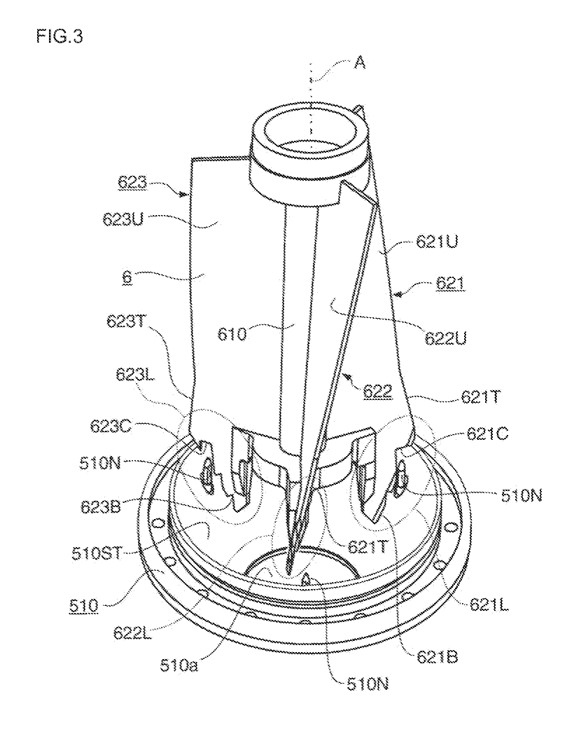

As shown in FIGS. 2 and 3, the wing 6 includes a wing main body 61 which is configured so that a plurality of plate-like blade parts 621 to 623 are formed to protrude outward in radial directions of rotation from a shaft member 610 serving as a rotation center, and the rotating shaft 62 which is provided coaxially with the shaft member 610 and protrudes upward from the wing main body 61. In the present embodiment, the three blade parts 621 to 623 are provided so that the blade parts having the same shape form an angle of 120 degrees between adjoining wings in a circumferential direction about the shaft member 610 which rotates about the rotation axis A. The blade surfaces of the respective blade parts 621 to 623 are formed to twist clockwise as viewed from above. The rotating shaft 62 of the wing 6 is inserted into the rotation support portion 520 of the rotating shaft 52 of the bowl 5 described above, whereby the entire wing 6 is rotatably supported with respect to the bowl 5 and the support member 244.

The blade parts 621 to 623 of the wing 6 each have an outer diameter smaller than the inner diameter of the bowl 5 so as to allow rotation relative to the bowl 5 inside the bowl 5.

The centrifuge 1 is further provided with a positioning mechanism for positioning the wing 6 and the bowl 5 to a predetermined phase about the rotating shafts, for example, to one point about the rotating shafts. Such a positioning mechanism includes a plurality of grooves and a plurality of protrusions to be fitted into the grooves, which are formed on the upper side of the respective rotating shafts 62 and 52 of the wing 6 and the bowl 5. The positioning mechanism is configured such that when the rotating shafts 62 and 52 are relatively rotated, the fitting portions are fitted into the respective corresponding grooves, so that the wing 6 and the bowl 5 are positioned by fitting only when coming to a predetermined angular position relationship about the rotating shafts.

In the present embodiment, the positioning mechanism includes an index ring 53 which is provided on the upper end of the rotating shaft 52 of the bowl 5, and an inner ring 63 which is detachably arranged on the upper end side of the rotating shaft 62 of the wing 6 and engages with the index ring 53. The protrusions are formed on the index ring 53 side, and the grooves are formed on the inner ring 63 side. It will be understood that the protrusions do not necessarily need to be provided on the index ring 53 side. For example, the protrusions may be provided on the inner ring 63 side, and the grooves to engage with the protrusions may be provided on the index ring 53 side. Both protrusions and grooves may be provided on the inner ring 63 side, and both grooves and protrusions to engage with the protrusions and grooves may be provided on the index ring 53 side.

This inner ring 63 has a generally annular shape in a plan view, with an outer diameter slightly smaller than the inner diameter of the index ring 53. A hole portion 631 having a generally circular shape in a plan view, for the rotating shaft 62 of the wing 6 to be fitted into, is formed in the center of the inner ring 63. A notch for a positioning protrusion (not shown) provided on the rating shaft 62 of the wing 6 to be fitted into is provided in the hole portion 631. A flange portion 632 is formed on the end side of the inner ring 63, whereby the lower portion facing the inner ring 53 is shaped to protrude outward. Grooves as many as the protrusions on the index ring 53 are formed in the flange portion 632 of the inner ring 63 at positions corresponding to the respective protrusions.

A coil spring 54 serving as biasing means for biasing the inner ring 63 and by extension the entire wing 6 upward is provided between the index ring 53 and the inner ring 63 so as to be inserted into the rotating shaft 62 of the wing 6.

In the present embodiment having such a configuration, if the inner ring 63 and the index ring 53 are relatively rotated about the rotating shaft 62 of the wing 6 with force for pressing the inner ring 63 toward the index ring 53 against the spring force of the coil spring 54 being applied, the not-shown protrusions of the index ring 53 are fitted into the not-shown grooves of the inner ring 63. The index ring 53 on the bowl 5 side and the inner ring 63 on the wing 6 side are thereby engaged with each other, so that the bowl 5 and the blade parts 6 become integrally rotatable. In the configuration described here, the bowl 5 and the wing 6 are made integrally rotatable by engaging the protrusions and the grooves of the index ring 53 and the inner ring 63. However, this is not restrictive. For example, the inner ring 63 may be pressed against the index ring 53 by the coil spring 54, so that the bowl 5 and the wing 6 are made integrally rotatable by friction resistance.

If the configuration of engaging the protrusions and the grooves of the index ring 53 and the inner ring 63 is employed, an engagement mechanism having a pattern that allows engagement only in a certain angular position relationship may be used to allow engagement of the index ring 53 and the inner ring 63 only in the certain angular position relationship. For example, the angular positions of the protrusions and the grooves around the respective rotating shafts may be irregularly spaced. If the bowl 5 and the wing 6 are configured to be integrally rotated during centrifugal separation and relatively rotated during a subsequent discharge of the solids cake and during cleaning, the positional relationship of the bowl 5 and the wing 6 about the rotating shafts does not necessarily return to the position for integral rotation when the relative rotation is stopped. High-speed rotation can cause vibrations from a slight imbalance, for example, due to manufacturing tolerance, in which case stable high-speed rotation may be not possible. Then, for example, a phase that minimizes vibrations may be determined in advance by conducting a test and the like. For integral rotation, the bowl 5 and the wing 6 can be positioned to the phase each time to achieve positioning in consideration of dynamic balance.

In the present invention, the positioning mechanism may be configured to be able to position the relative position of the wing 6 and the bowl 5 about the rotating shafts to only one point where the dynamic balance is the most favorable. However, the number of such points does not necessarily need to be one. The relative position may be configured to be positioned to a plurality of points within a range where the dynamic balance is acceptable.

Next, the configuration of the wing 6 and the bowl 5 according to the present embodiment will be described in more detail.

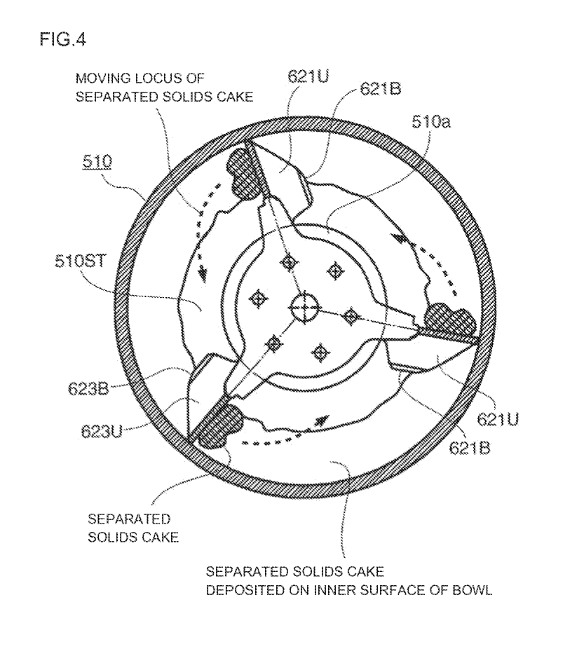

As shown in FIGS. 1 to 3, protrusions 510N protruding from an inner peripheral surface 510ST of the tapered section 510 of the bowl 5 according to the present embodiment are provided in a plurality of circumferential locations (for example, three locations) on the inner peripheral surface 510ST. In view of weight balance during a centrifugal separation operation, the plurality of protrusions 510N are desirably provided at equal angular intervals (for example, at intervals of 120 degrees) from each other as viewed from above (see FIG. 4).

The protrusions 510N are needles (bar-like members) protruding vertically upward from the inner peripheral surface 510ST of the tapered section 510 of the bowl 5. The upper ends of the protrusions 510N are pointed in a conical shape. The bottom portions are screwed to the inner peripheral surface 510ST of the tapered section 510.

Notches 621C to 623C are formed in lower portions (621L to 623L shown in FIG. 3) of the respective blade parts 621 to 623 of the wing 6 corresponding to the protrusions 510N so that the blade parts 621 to 623 do not collide with the protrusions 510N when the wing 6 and the bowl 5 are relatively rotated about the vertical axis A. Edges 621B to 623B are provided on the lower ends of the respective blade parts 621 to 623.

While the protrusions here are provided in three locations as an example, this is not restrictive. The number of protrusions 510N provided can be appropriately adjusted according to the inner diameter of the bowl 5. In the present embodiment, the number of blade parts of the wing 6 is three, and the number of protrusions 510 is also three. However, the number of blade parts of the wing 6 and the number of protrusions 510N do not necessarily need to be the same as long as the separated solids cake in the bowl 5 can consequently be conveyed to the opening 510a.

A plurality of nozzles 615 for cleaning the blade surfaces of the blade parts 621 to 623 and the inner surface of the bowl 5 are provided on the shaft member 610 of the wing 6. For convenience of description, the nozzles 615 are omitted in FIGS. 3 and 4. These nozzles 615 eject a cleaning solution supplied from a cleaning solution feed pipe 80 and passed through the internal space of the shaft member 610 at high pressure laterally, i.e., outward in radial directions of rotation of the respective blade parts 621 to 623 and vertically, i.e., toward the upper/lower sides of the respective blade parts 621 to 623. Each nozzle 615 has a flat-shaped ejection port, and ejects the supplied cleaning solution to spread out flatly.

Of the plurality of nozzles 615, the laterally-ejecting ones are arranged in numbers (for example, six for each blade part) on the shaft member 610 of the wing main body 61 at predetermined intervals. The respective laterally-ejecting nozzles are desirably arranged at intervals such that the ejected cleaning solutions somewhat overlap each other. The vertically-ejecting nozzles are arranged one toward the upper side and one toward the lower side of the wing (for example, two for each blade part) on the shaft member 610 of the wing main body 61. The vertically-ejecting nozzles are arranged in positions such that the ejecting direction of the liquid to be treated does not interfere with the ejecting directions of the cleaning solution from the respective vertically-ejecting nozzles.

In the present embodiment, a row of laterally-ejecting nozzles and a row of vertically-ejecting nozzles are provided on the shaft member 610 for each wing. In the present embodiment, the configuration including the three blade parts is thus provided with three rows of laterally-ejecting nozzles and three rows of vertically-ejecting nozzles (a total of 24 nozzles).

The types and numbers of nozzles provided on the wing 6 are not limited in particular, and may be appropriately changed according to the ejecting direction (spreading angle) of the cleaning solution from each nozzle, the size of the wing, etc. Both laterally-ejecting nozzles and vertically-ejecting nozzles do not necessarily need to be provided. Either one type may be provided on the wing 6.

### <Description of Operations>

Respective operations of the centrifuge 1 will be described below.

### (During Centrifugal Separation)

Initially, a basic operation of the centrifuge 1 when centrifugally separating the liquid to be treated will be described. In the state shown in FIG. 1, the entire wing 6 is relatively located above by the biasing force of the coil spring 54, so that the bowl 5 and the wing 6 are in an engaged state capable of integral rotation. In such a state, if the wing driving motor 73 is moved downward by the cylinder 241, the end of the drive shaft of the wing driving motor 73 and the upper end of the rotating shaft 62 of the wing 6 are coupled together by the foregoing coupler structure. By such an operation, the inner ring 63 in the state of engagement with the index ring 53 is lowered relative to the index ring 53 according to the lowering operation of the wing driving motor 73. This disengages the inner ring 63 and the index ring 53, and the wing 6 becomes capable of a rotating operation relative to the bowl 5.

The not-shown actuator is then driven so that the brake 243 is ON, i.e., makes contact with the rotating shaft 52 of the bowl 5. Such an operation brings the bowl 5 into a state of being fixed to the support member 244 and the casing 4. With the bowl 5 in the fixed state, the wing driving motor 73 is driven to rotate the entire wing 6. Here, the protrusions of the index ring 53 are fitted into the grooves of the inner ring 63 of the foregoing positioning mechanism, and the inner ring 63 and the index ring 53 are engaged in a predetermined position. The position (phase) of the wing 6 and the bowl 5 about the shafts is thereby set to the positional relationship capable of high-speed rotation in consideration of dynamic balance.

Next, the wing driving motor 73 is retracted upward by the cylinder 241. The entire wing 6 is lifted to a first height position by the biasing force of the coil spring 54, and the coupling between the end of the drive shaft of the wing driving motor 73 and the upper end of the rotating shaft 62 of the wing 6 is released. Here, the tapered section 511 of the bowl 5 and tapered sections 621T to 623T of the respective blade parts of the wing 6 may be configured to come into contact and engagement with each other so that the wing 6 and the bowl 5 are integrally rotatably fixed to each other. The tapered section 511 of the bowl 5 and the tapered sections 621T to 623T of the respective blade parts of the wing 6 are configured to be capable of contact and engagement with each other, and consequently, the wing 6 and the bowl 5 can make integral rotation more stable than with the configuration where only the grooves of the inner ring 63 and the projections of the index ring 53 are engaged with each other.

Next, the main body driving motor 71 is driven in such a state. If the main body driving motor 71 reaches a predetermined number of rotations, the liquid to be treated is supplied from the feed pipe 42 into the bowl 5. By such an operation, the wing 6 and the bowl 5 are integrally rotated at high speed (for example, clockwise as viewed from above) and the solid-liquid separation operation of the supplied liquid to be treated is started. The bowl 5 and the wing 6 will hereinafter be referred to collectively as a “rotor.” In such high-speed rotations, the number of rotations and the centrifugal force of the rotating cylindrical body reach approximately 10000 rpm/20000 G. As described above, the rotating cylindrical body rotates with the phase of the bowl 5 and the wing 6 in position in consideration of dynamic balance. According to the centrifuge 1 of the present embodiment, the rotational movement therefore stabilizes by a so-called gyroscopic effect as the rotation speed of the rotating cylindrical body increases. This can suppress vibrations occurring during centrifugal separation despite the cantilevered support structure. In addition, according to the centrifuge 1 of the present embodiment, the diameter of the bowl can be made relatively large as compared to a centrifuge of conventional double-supported structure in which vibrations occurring during centrifugal separation are absorbed by both top and bottom bearings.

According to such a centrifuge 1, during centrifugal separation of the liquid to be treated, the separated light liquid is discharged from the uppermost light liquid discharge portion 25 and the heavy liquid is discharged from the heavy liquid discharge portion 43 below by the action of extremely high centrifugal force. The separated solids cake (cake) is accumulated in the rotating cylindrical body.

If a certain amount (for example, approximately 40 liters) of solids cake is accumulated in the rotating cylinder, the supply of the liquid to be treated is stopped and the driving of the main body driving motor 71 is stopped to stop the rotation of the rotating cylindrical body. This completes the solid-liquid separation operation.

Hereinafter, an automatic discharge operation of the separated solids cake accumulated in the bowl 5 according to the present embodiment will be described.

In the foregoing state where the rotating cylinder is stopped (the state where the wing 6 is at the first height position), the wing driving motor 73 is lowered by the cylinder 241 to couple the drive shaft of the wing driving motor 73 and the rotating shaft 62 of the wing 6.

In such a state, the wing driving motor 73 is further lowered by the cylinder 241, whereby the wing 6 is lowered to a second height position and the engagement between the grooves of the inner ring 63 and the protrusions of the index ring 53 is disengaged. Such a movement of the wing 6 to the second height position lower than the first height position makes the wing 6 rotatable relative to the bowl 5.

In the present embodiment, a drive mechanism including, for example, the cylinder 241, the wing driving motor 73, the inner ring 63, the index ring 53, the coil spring 54, and the like can move the wing 6 to the first height position to integrally rotate the wing 5 and the wing 6. The wing 6 can be moved to the second height position lower than the first height position to rotate at least either one of the wing 6 and the bowl 5 so that the wing 6 rotates relative to the bowl 5 in a predetermined direction of rotation.

Next, the lid 41 is detached from the casing 4. The separated solids cake discharged from the hole portion 510a serving also as a discharge port can thus be taken out of the casing 4.

Next, the brake 243 is turned ON by the not-shown actuator, so that the rotating shaft 52 of the bowl 5 is fixed to the support member 244 and the casing 4. With the bowl 5 fixed not-rotatably, the wing driving motor 73 is driven to rotate only the wing 6 in a predetermined direction (counterclockwise as viewed from above). As a result, the separated solids cake accumulated in the bowl 5 is scraped by the blade parts 621 to 623 of the wing 6 and discharged out of the bowl from the hole portion 510a of the bowl 5. The discharged solids cake falls out from the lower side of the casing 4 where the lid 41 is detached.

As described above, according to the centrifuge 1 of the present embodiment, the solids cake occurring during the centrifugal separation processing and accumulated in the bowl 5 can be automatically discharged without detaching the bowl 5 from the casing 4.

The separated solids cake (cake) accumulated in the bowl 5 may have high viscosity and cause excessive load on the wing driving motor 73. The separated solids cake annularly accumulated along the inner peripheral surface of the bowl 5 may slide over the inner surface of the bowl 5, in which case the separated solids cake is difficult to convey to the hole portion 510a by only rotating the wing 6. Even in such cases, to discharge the separated solids cake out of the bowl 5, the centrifuge according to the present embodiment lowers the wing with respect to the bowl 5 to allow rotation of the wing 6 relative to the bowl 5. The lower ends of the lowered wing then push down the separated solids cake, and the separated solids cake is pierced by the needle tops of the protrusions 510N. Consequently, if the wing is rotated in the predetermined direction of rotation (counterclockwise as viewed from above) after the wind 6 is lowered to the second height position, the separated solids cake will not slide inside the bowl 5 to rotate with the wing 6 since the protrusions 510N are biting into the separated solids cake. As a result, the blade parts 621 to 623 of the rotating wing 6 convey the separated solids cake which is non-rotatably caught by the protrusions 510N on the inner surface of the bowl 5. The annularly-accumulated separated solids cake is torn by the rotating operation of the wing 6 and easily conveyed to the hole portion 510a.

Before rotation and/or during a rotation operation of the wing 6, a cleaning solution may be ejected from the jet nozzles 615 to facilitate the discharge of the separated solids cake from the bowl 5. If the target substance is a separated liquid, a cleaning solution may be similarly ejected to facilitate the discharge of the separated solids cake.

In short, by the foregoing operation of the centrifuge 1, a separated solids cake having relatively high viscosity can be automatically discharged out of the bowl 5. This can significantly reduce the time, cost, and the like needed for subsequent cleaning of the interior of the bowl 5. Specifically, the bowl 5 does not need to be detached from the casing 4. Depending on the type of the liquid to be treated and for the sake of maintenance and the like, the bowl 5 may be detached from the casing 4 and cleaned further. Even in such cases, the time and cost to complete cleaning are significantly reduced. Consequently, the time and cost to complete cleaning, for example, when handling food or chemicals as the liquid to be treated can be significantly reduced as compared to a conventional centrifuge.

In the present embodiment, as an example, the bowl 5 and the wing 6 are configured to be integrally rotated (in a clockwise direction of rotation as viewed from above) during a centrifugal separation operation. When discharging the separated solids cake out of the bowl 5, the bowl 5 is stopped and only the wing 6 is rotated in a predetermined direction (counterclockwise as viewed from above). However, the centrifuge is not necessarily limited thereto.

For example, the direction in which to integrally rotate the bowl 5 and the wing 6 during a centrifugal separation operation does not necessarily need to be clockwise as viewed from above. The bowl 5 and the wing 6 may be configured to be rotated counterclockwise as viewed from above.

The wing 6 does not necessarily need to be configured to be rotated alone with the bowl 5 stopped when discharging the separated solids cake after the centrifugal separation operation. For example, only the bowl 5 may be rotated with the wing 5 stopped so that the direction of rotation of the wing 6 relative to the bowl 5 is the predetermined direction.

A drive mechanism for rotating both the bowl 5 and the wing 6 may be employed so that the direction of rotation of the wing 6 relative to the bowl 5 is the predetermined direction when discharging the separated solids cake after the centrifugal separation operation.

### Second Embodiment

Next, a second embodiment of the present invention will be described. The second embodiment of the present invention is a modification of the foregoing first embodiment. Hereinafter, portions having the same functions as those of the parts already described in the first embodiment will be designated by the same reference numerals. A description thereof will be omitted.

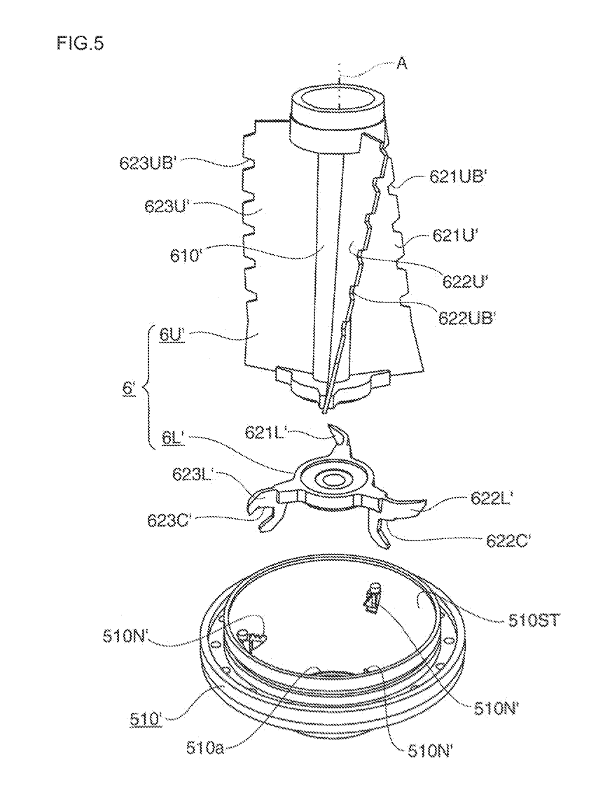

In the foregoing first embodiment, the notches 621C to 623C for avoiding interference with the protrusions are formed in the respective lower parts 621L to 623L of the plurality of blade parts 621 to 623 constituting the wing 6. In the present embodiment, the blade parts are each divided into an upper wing and a lower wing, and the lower wing is configured to be detachably attachable to the lower end of the upper wing (FIG. 5).

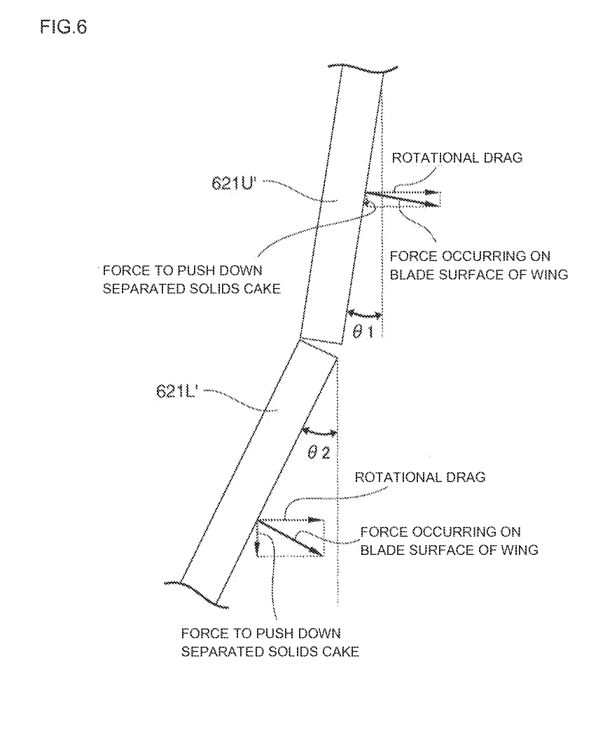

Specifically, a wing 6′ according to the present embodiment includes an upper wing 6U′ including blade parts 621U′ to 623U′ which have a blade surface titled by a first tilt angle θ1 (see FIG. 6) in a predetermined direction of rotation (here, counterclockwise as viewed from above) with respect to a vertical direction, and a lower wing 6L′ including blade parts 621L′ to 623L′ which are located below the upper wing 6U′ and have a blade surface tilted by a second tilt angle θ2 (see FIG. 6) greater than the first tilt angle θ1 in the predetermined direction of rotation (here, counterclockwise as viewed from above) with respect to the vertical direction.

Moreover, notches 621C′ to 623C′ are formed in portions of the blade parts 621L′ to 623L′ corresponding to the protrusions.

Since the lower wing 6L′ is configured to be detachably attachable to the upper wing 6U′, a lower wing having an optimum tilt angle and blade shape can be selected according to the characteristics of the solids cake contained in the liquid to be treated, such as viscosity, shape, and grain size. The difficulty of discharging the separated solids cake occurs in the diameter-reduced portion around the inner peripheral surface 510ST of the tapered section 510. The upper wing 6U′ is less likely to need to be replaced according to the properties of the separated solids cake. Selecting and replacing only the lower wing according to the characteristics of the liquid to be treated can thus improve the discharge performance of the separated solids cake without an extensive operation of detaching the upper wing.

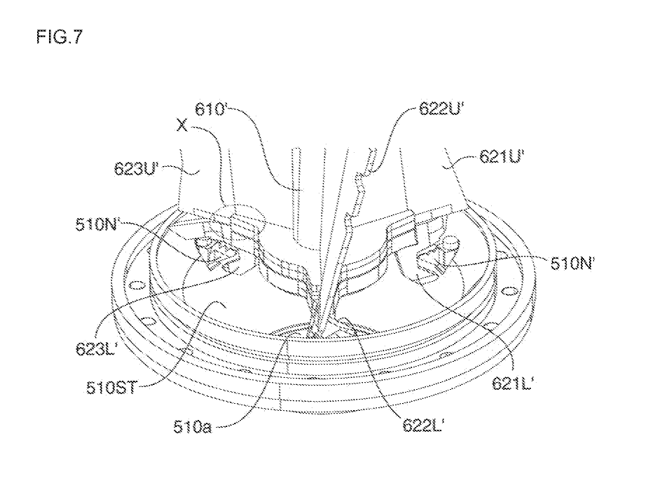

In the present embodiment, the lower wing 6L′ includes three blade parts 621L′ to 623L′. The upper wing 6U′ similarly includes three blade parts 621U′ to 623U′. At least part of the respective lower ends of the plurality of blade parts 621U′ to 623U′ constituting the upper wing 6U′ and at least part of the respective upper ends of the plurality of lower portions 621L′ to 623U′ coincide in terms of the angular position in the direction of rotation (see position X in FIG. 7).

As described above, the lower end of the upper wing 6U′ and the upper end of the lower wing 6L′ are configured to coincide at least in part in the angular position in the direction of rotation. The separated solids cake moving from the upper wing side to the lower wing side is therefore not caught by the upper end of the lower wing at least in the coincident portions. This can consequently reduce the conveyance resistance of the solid separated substance during discharge.

In the present embodiment, the tilt angle of the blade surfaces of the blade parts 621U′ to 623U′ constituting the upper wing 6U′ with respect to the vertical direction is the first tilt angle θ1 (see FIG. 6) counterclockwise as viewed from above. The tilt angle of the blade surfaces of the blade parts 621L′ to 623L′ constituting the lower wing 6L′ with respect to the vertical direction is the second tilt angle θ2 (seen FIG. 6) greater than the first tilt angle θ1 counterclockwise as viewed from above.

Consequently, as shown in FIG. 6, if the wing 6′ is rotated counterclockwise as viewed from above, the force occurring on the blade surfaces to push down the separated solids cake is greater on the lower wing 6L′ than on the upper wing 6U′. This can improve the downward conveyance performance of the separated solids cake near the tapered section 510 in the bowl 5 where the conveyance of the separated solids cake to the hole portion 510a is difficult in particular.

With the lower wing 6L′ according to the present embodiment, the blade surfaces near the portions where the notches 621C′ to 623C′ are formed are tilted in the predetermined direction of rotation (counterclockwise as viewed from above) with respect to the radial directions of rotation of the wing 6.

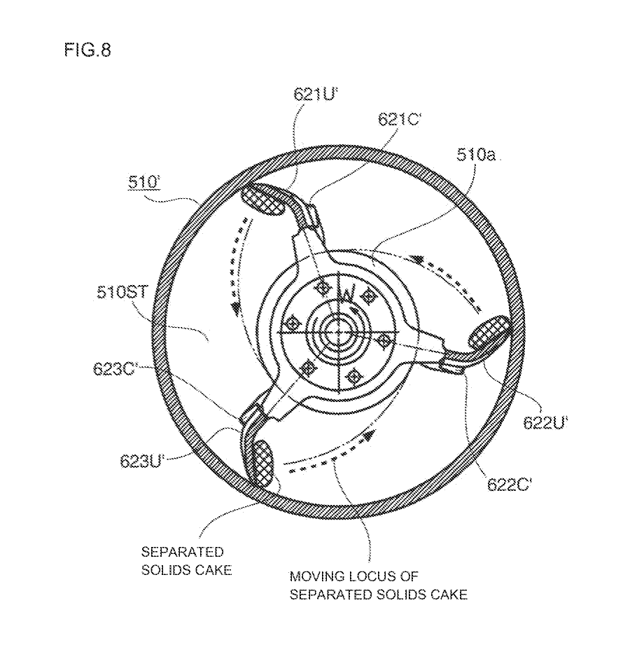

If a wing having blade surfaces extending straight in radial directions of rotation from the rotation center is used to guide the separated solids cake to the discharge port of the bowl, the separated solids cake in the bowl may fail to descend smoothly toward the discharge port since the tapered surface of the lower part of the bowl is shaped to decrease in radius toward the opening. In contrast, according to the configuration of the present invention, when the wing 6′ rotates relative to the bowl 5 in the predetermined direction, the blade surfaces near the portions of the wing where the notches are formed scrape up the separated solids cake in the bowl toward the rotation center of the bowl. The separated solids cake can thus be efficiently guided toward the opening in the lower part of the bowl (FIG. 8).

Here, the blade surfaces of the respective wings are tilted counterclockwise as viewed from above with respect to the vertical direction and at least part of the blade surfaces near the portions of the respective wings where the notches are formed are tilted counterclockwise as viewed from above with respect to the radial directions of rotation. However, this is not necessarily restrictive. The blade surfaces of the respective wings may be tilted clockwise as viewed from above with respect to the vertical direction and the blade surfaces near the portions of the respective wings where the notches are formed may be tilted clockwise as viewed from above with respect to the radial directions of rotation. In such a case, when relatively rotating the wing to discharge the separated solids cake out of the bowl, the wing is rotated relative to the bowl clockwise as viewed from above.

Unlike the first embodiment, in the present embodiment, plate-like members protruding from the inner peripheral surface 510ST of the tapered section 510 of the bowl 5 are employed as protrusions 510N′.

Like the first embodiment, such plate-like protrusions 510N′ are screwed to the inner peripheral surface 510ST of the tapered section 510 of the bowl 5. Edges are formed on top of the protrusions 510N′.

Consequently, when the wing is lowered, the separated solids cake (cake) annularly remaining in the bowl can be cut by the edges of the protrusions and easily discharged from the discharge port by the wing. Even if the separated solids cake is not able to be cut, the protrusions can bite into and prevent the separated solids cake from sliding in the bowl, whereby the separated solids cake can be torn and discharged by the wing.

The edges formed on the plate-like members of the protrusions 510N′ form tilted surfaces descending from the upstream side to the downstream side in a predetermined direction of rotation (counterclockwise as viewed from above) (see FIG. 7). This provides the effect of facilitating the edges of the protrusions biting into the separated solids cake which is moved in a predetermined direction of relative rotation with respect to the bowl by the rotation of the wing.

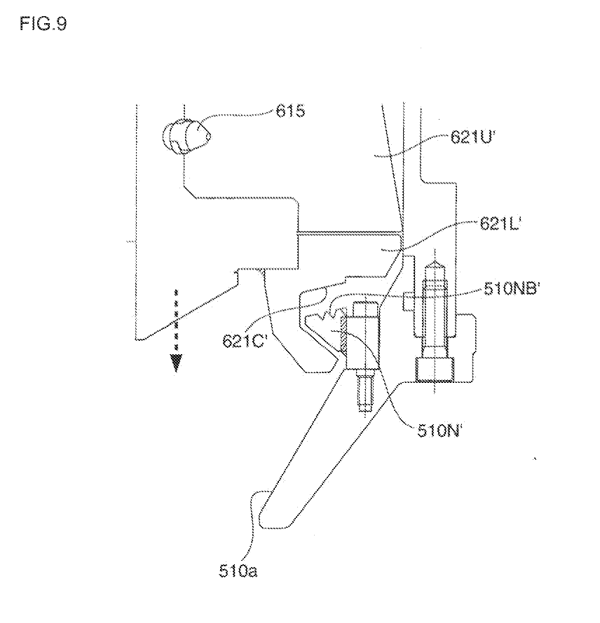

Moreover, as shown in FIG. 9, the edges formed on the plate-like members of the protrusions 510N′ are tilted to descend gradually from the outer side in the radial directions of rotation to the rotation center side of the bowl (In FIG. 9, from the right to the left side).

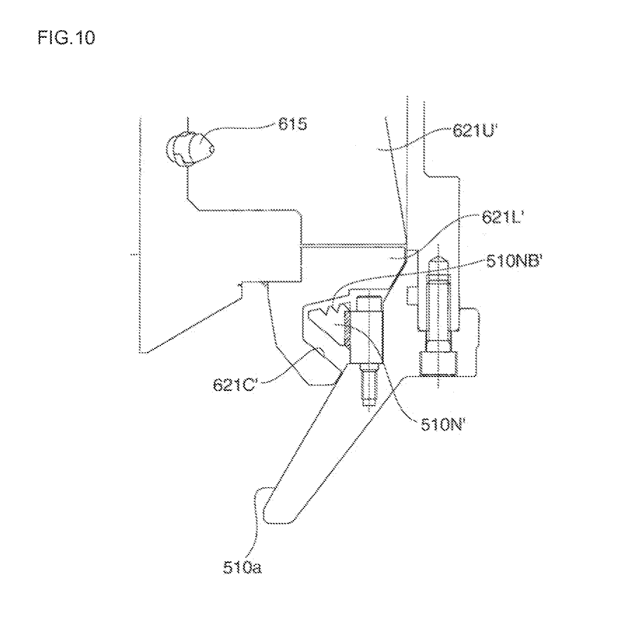

The edges having such a shape can be employed to minimize the area of the notches provided on the wing side, and secure a strength to bear the centrifugal force occurring when the wing is rotated at high speed. When the wing is rotated relative to the bowl to discharge the separated solids cake from the hole portion 510a, the edges formed on the plate-like members of the protrusions 510N′ obliquely come into contact with the bottom surface of the separated solids cake (cake) pushed down by the lowering of the wing. This provides the effect of making it easier to cut the separated solids cake by the edges (see FIGS. 9 and 10).

The wing 6′ according to the present embodiment has notches 621UB′ to 623UB′ which are formed in the outer ends of the respective blade parts 621U′ to 623U′ of the upper wing 6U′ in radial directions of rotation. The provision of such notches 621UB′ to 623UB′ can reduce load acting on the wing driving motor 73 when rotating the wing 6′. The wing 6′ having such notches 621UB′ to 623UB′ can also break and agitate the annularly-accumulated separated solids cake. This can consequently improve the conveyance efficiency of the separated solids cake to the hole portion 510a.

### Third Embodiment

Next, a third embodiment of the present invention will be described. The third embodiment of the present invention is a modification of the foregoing embodiments. Hereinafter, portions having the same functions as those of the parts already described in the foregoing embodiment will be designated by the same reference numerals. A description thereof will be omitted.

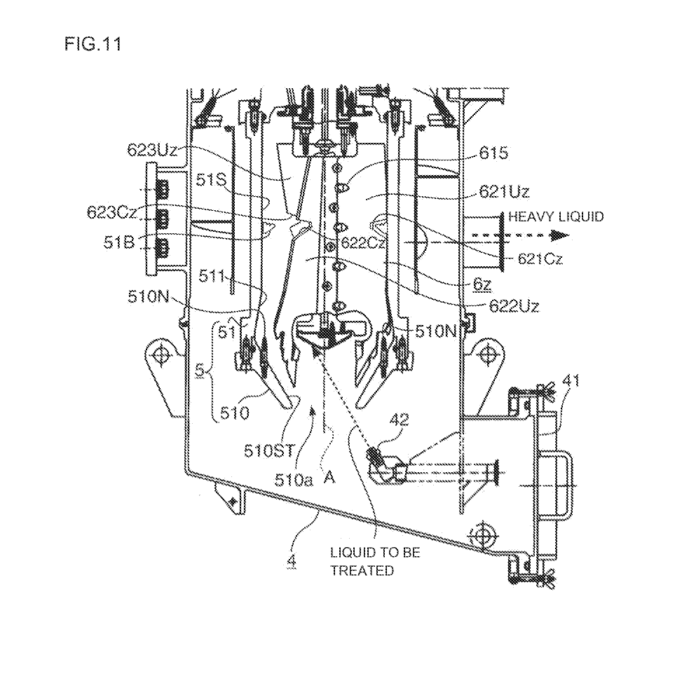

In the foregoing embodiments, the protrusions are provided on the inner peripheral surface 510ST so that the separated solids cake separated in the bowl and annularly accumulated on the inner peripheral surface of the bowl does not slide over the inner peripheral surface 510ST. In the present embodiment, as shown in FIG. 11, protrusions 51B are also provided on the cylindrical surface above the inner peripheral surface 510ST of the tapered section 510 of the bowl 5.

Notches 621Cz to 623Cz for avoiding interference with the protrusions 51B are accordingly formed in the outer ends in the radial directions of rotation of respective blade parts 621z to 623z constituting a wing 6z according to the present embodiment at positions corresponding to the protrusions 51B. In the example shown in FIG. 11, the protrusions 51B are provided near the center in the height direction of the bowl 5. However, this is not restrictive. It will be understood that the protrusions 51B may be provided as appropriate according to various factors including the properties of the separated solids cake contained in the liquid to be treated, the shapes of the blades constituting the wing, the coefficient of friction of the inner surface of the bowl 5, the tilt angle of the inner peripheral surface 510ST of the tapered section 510, and the size of the hole portion 510a. As employed herein, the protrusions 510N provided on the inner peripheral surface 510ST of the tapered section 510 and the protrusions 51B have different shapes. However, this is not restrictive. Protrusions having the same shape may be employed.

### Fourth Embodiment

Next, a fourth embodiment of the present invention will be described. The fourth embodiment of the present invention is a modification of the foregoing embodiments. Hereinafter, portions having the same functions as those of the parts already described in the foregoing embodiments will be designated by the same reference numerals. A description thereof will be omitted.

In the foregoing embodiments, to avoid a situation where the separated solids cake annularly accumulated in the bowl rotates integrally with the wing and becomes difficult to discharge from the hole portion in the lower part of the bowl after centrifugal separation, various protrusions are provided to prevent the separated solids cake from sliding over the inner surface of the bowl, or the inner peripheral surface 510ST in particular. However, this is not necessarily restrictive.

That is, the centrifuge has only to be configured such that the separated solids cake is less likely to slide (has high sliding resistance) over the inner surface of the bowl, or the inner peripheral surface 510ST in particular, when a solids cake discharge operation by the wing is performed.

Specifically, in the present embodiment, a plurality of grooves 510G extending radially from the hole portion 510a are formed in the inner peripheral surface 510ST of the tapered section 510 of the bowl. As a result, the separated solids cake conveyed in contact with the inner peripheral surface 510ST is less likely to slide over the inner peripheral surface 510ST and more likely to be conveyed downward by the conveyance force of a wing 6″.

Such grooves do not necessarily need to be formed in the inner peripheral surface 510ST of the tapered section 510. For example, grooves may also be formed in the inner surface of the bowl other than the inner peripheral surface 510ST.

Moreover, the grooves formed as means for providing the inner surface of the bowl with sliding resistance do not necessarily need to be formed radially about the rotation axis. For example, the grooves may be formed as spiral traces extending generally in parallel with the moving loci of the separated solids cake actually conveyed by the wing.

Consequently, according to the present embodiment, a centrifuge can be provided which includes, for example:
a bowl which rotates about a vertical axis, has an opening functioning as a supply port of a liquid to be treated and also functioning as a discharge port of a separated solids cake centrifugally separated from the liquid to be treated, the opening being provided in a center of a lower part of the bowl, and has a tapered section of which an inner peripheral surface decreases in radius downward toward the opening, at least the inner peripheral surface of the tapered section being provided with sliding resistance providing means for providing a sliding resistance for the separated solids cake;
a wing which rotates within the bowl about the vertical axis and conveys the separated solids cake in the bowl toward the opening when rotating relative to the bowl in a predetermined direction of rotation; and
a drive mechanism which moves the wing to a first height position to integrally rotate the bowl and the wing, and moves the wing to a second height position lower than the first position to rotate at least either one of the wing and the bowl so that the wing rotates relative to the bowl in the predetermined direction of rotation.

Furthermore, the configuration described in each of the foregoing embodiments does not necessarily need to include only the described configuration. It will be understood, for example, that the configurations described in the foregoing embodiments may be arbitrarily combined. Specifically, for example, the grooves 510G described in the fourth embodiment may be employed in the first to third embodiments. The protrusions 51B described in the third embodiment and the corresponding notches may be employed in the first, second, and fourth embodiments.

It should be noted that the configurations described in the foregoing embodiments are merely illustrative. For example, even if part or all of the components of the configurations described in the respective embodiments are changed in shape, size, number, positional relationship, material, and/or the like, such configurations may be regarded as including indispensable components of the centrifuge according to the present invention as long as equivalent functions to those of respective indispensable components constituting the centrifuge according to the present invention are substantially included and the operations thereof are the same. Moreover, even if at least one of the components constituting the centrifuges according to the foregoing embodiments is replaced with alternative means having an equivalent function, such configurations may be regarded as substantially including the constitution requirements of the centrifuge according to the present invention.

The present invention may be practiced in various other forms without departing from the spirit or essential characteristics thereof. The foregoing embodiments are therefore to be considered in all respects as merely illustrative and not restrictive. The scope of the invention is indicated by the appended claims rather than by the foregoing description. All changes which come within the meaning and range of equivalency of the claims are therefore intended to be embraced therein.

### REFERENCE SIGNS LIST

1 centrifuge

2 frame

244 support member

241 cylinder

243 brake

3 centrifuge main body

4 casing

5 bowl

510 taper section

52 rotating shaft

53 index ring

54 coil spring

510N protrusion

51B protrusion

510G groove

6, 6′, 6″, 6z wing

63 inner ring

610 shaft member

621 to 623 blade part

621C to 623C notch

621Cz to 623Cz notch

6U′ upper wing

6L′ lower wing

71 main body driving motor

73 wing driving motor

1. A centrifuge comprising:
a bowl which rotates about a vertical axis, has an opening functioning as a supply port of a liquid to be treated and also functioning as a discharge port of a separated solids cake centrifugally separated from the liquid to be treated, the opening being provided in a center of a lower part of the bowl, and has a tapered section of which an inner peripheral surface decreases in radius downward toward the opening;
protrusions which are provided in a plurality of circumferential locations on the inner peripheral surface of the tapered section of the bowl and protrude from the inner peripheral surface;
a wing which rotates within the bowl about the vertical axis and conveys the separated solids cake in the bowl toward the opening when rotating relative to the bowl in a predetermined direction of rotation; and
a drive mechanism which moves the wing to a first height position to integrally rotate the bowl and the wing, and moves the wing to a second height position lower than the first height position to rotate at least either one of the wing and the bowl so that the wing rotates relative to the bowl in the predetermined direction of rotation, wherein
a portion of the wing corresponding to the protrusion is notched into a shape not to collide with the protrusions when the wing and the bowl rotate relative to each other.

2. The centrifuge according to claim 1, wherein:
the wing includes an upper wing having a blade surface that is tilted by a first tilt angle in the predetermined direction of rotation with respect to a vertical direction, and a lower wing having a blade surface that is located below the upper wing and tilted by a second tilt angle greater than the first tilt angle in the predetermined direction of rotation with respect to the vertical direction; and
a notch is formed in a portion of the lower wing corresponding to the protrusions.

3. The centrifuge according to claim 2, wherein the lower wing is detachably attachable to the upper wing.

4. The centrifuge according to claim 2, wherein:
the lower wing and the upper wing include the same number of blades each; and
at least part of respective lower ends of the plurality of blades constituting the upper wing and at least part of respective upper ends of the plurality of blades constituting the lower wing coincide in terms of a position in a direction of rotation.

5. The centrifuge according to claim 1, wherein a blade surface near the notched portion of the wing is tilted in the predetermined direction of rotation with respect to a radial direction of rotation.

6. The centrifuge according to claim 1, wherein the protrusions include a plate-like member protruding from the inner peripheral surface of the tapered section of the bowl.

7. The centrifuge according to claim 6, wherein an edge is formed on an upper part of the plate-like member.

8. The centrifuge according to claim 7, wherein the edge formed on the plate-like member forms a tilted surface descending from an upstream side to a downstream side in the predetermined direction of rotation.

9. The centrifuge according to claim 7, wherein the edge formed on the plate-like member is tilted to descend gradually from an outer side in a radial direction of rotation to a rotation center side of the bowl.

10. The centrifuge according to claim 1, wherein the protrusions include a bar-like member protruding from the inner peripheral surface of the tapered section of the bowl.

11. The centrifuge according to claim 10, wherein the bar-like member is a needle extending vertically upward from the inner peripheral surface of the tapered section of the bowl.
